(19) United States
(12) Patent Application Publication
(10) Pub. No.: US 2018/0281325 A1
(43) Pub. Date: Oct. 4, 2018

(54) APPARATUS FOR MAKING CONICAL BELLOWS

(71) Applicant: Contitech Luftfedersysteme GmbH, Hannover (DE)

(72) Inventors: Winfried Reisch, Wunstorf (DE); Ruediger Lommatzsch, Isernhagen (DE)

(21) Appl. No.: 16/000,562

(22) Filed: Jun. 5, 2018

Related U.S. Application Data
(63) Continuation of application No. PCT/EP2016/073857, filed on Oct. 6, 2016.

(30) Foreign Application Priority Data
Dec. 11, 2015 (DE) 10 2015 224 964.6

(51) Int. Cl. B29D 22/02; B29C 33/48; B30B 11/00

(52) U.S. Cl. CPC B29D 22/023; B30B 11/007; B29C 33/485

(57) ABSTRACT

The invention is directed to an apparatus for making conical bellows for air springs. The apparatus includes a clamping/spreading device transferable between first and second end positions corresponding to an introduction position and a vulcanization position, respectively. The external diameter of the device in the first end position is less than the external diameter thereof of the second end position. The device has clamping segments which in the introduction position are converged so that the external diameter of the device enables an air spring bellows preform to be pushed over the device, and the clamping segments in the vulcanization position are diverged increasing the external diameter of the device so that the bellows preform is pressed tightly against the corresponding external form from the inside. Open gaps because of the enlargement of the external diameter of the device remain between the clamping segments.

### CROSS REFERENCE TO RELATED APPLICATIONS

This application is a continuation application of international patent application PCT/EP2016/073857, filed Oct. 6, 2016, designating the United States and claiming priority from German application 10 2015 224 964.6, filed Dec. 11, 2015, and the entire content of both applications is incorporated herein by reference.

### FIELD OF THE INVENTION

The invention relates to an apparatus for making conical bellows for air springs, having at least one clamping/spreading device, wherein two end positions, specifically an introduction position and a vulcanization position, are attainable by the clamping/spreading device, wherein the external diameter of the introduction position is smaller than the external diameter of the vulcanization position.

### BACKGROUND OF THE INVENTION

When being vulcanized, air spring bellows, which can be supported and sealed on adjacent components by way of conical seats, are usually supported inside respective molds by so-called heating bellows. DE 195 32217 C1 shows a heating bellows of this type.

In the vulcanization using heating bellows, pressure and temperature are transmitted by hot steam by way of the heating bellows to the preform. It can be readily perceived that the heat required for the cross-linking of the natural rubber in the vulcanization using heating bellows requires more time to reach the preform. For this reason, the vulcanization time of vulcanization without heating bellows is shorter than that of the vulcanization with heating bellows.

It is therefore desirable that bellows having conical seal seats can also be vulcanized without heating bellows.

A corresponding device which implements the required seal of the bellows preform inside the mold by way of a clamping and spreading device is disclosed in DE 10103257 A1 incorporated herein by reference. In the case of this device, two locking-bar and segment systems that are disposed in a reciprocal manner in the relaxed state reduce the external diameter of the device and thus enable the preform to be pushed over. The beads are sequentially tensioned from the inside in a form-fitting manner by spreading the locking bars and segments, and are thus sealed for the tubeless vulcanization.

However, this device is relatively complex and prone to defects, since the raw rubber in the vulcanization can penetrate the as yet present gaps of the clamping and spreading device.

### SUMMARY OF THE INVENTION

It is an object of the invention to provide an apparatus of the type mentioned above wherein a vulcanization of air spring preforms having a conical seat without heating bellows is significantly simplified.

This object is achieved in that the clamping/spreading device has clamping segments which, in the introduction position, are converged in such a manner that the external diameter of the clamping/spreading device enables an air spring bellows preform to be pushed over, and the clamping segments in the vulcanization position are diverged in such a manner that the external diameter of the clamping/spreading device is enlarged in such a manner that the air spring bellows preform is capable of being pressed tightly against the corresponding external shape from the inside, wherein open gaps caused by the enlargement of the external diameter of the clamping/spreading device remain between the segments.

The rubber of the bellows preform is softened in the vulcanization such that the bellows preform has protuberances that, between the clamping segments of the clamping/spreading device, protrude into the interior of the bellows. However, since the bellows preform has at least one reinforcement embedded in the rubber, in most instances a woven textile fabric, the rubber, because of the textile fabric, is sufficiently supported such that the woven fabric in the protuberances of the bellows in the gaps cannot be pressed through the latter. A flawless vulcanization of the bellows in the interior of the bellows is thus also ensured in the configuration of the protuberances.

In one embodiment of the invention, the width of the open gaps between the clamping segments of the clamping/spreading device in the vulcanization position is between 1 and 30 mm.

In one embodiment of the invention, the width of the open gaps between the clamping segments of the clamping/spreading device in the vulcanization position is between 3 and 25 mm.

Depending on the number of clamping segments and the diameter conditions, these geometries have been shown to be optimal in tests, such that the threads of the reinforcement lie such that the threads cannot be pressed through the rubber. A reliable sealing of the bellows during the vulcanization and the tightness of the bellows in the fully vulcanized state are thus provided.

In one embodiment of the invention, the clamping/spreading device has at least three clamping segments.

A particularly non-critical configuration of the protuberances mentioned is evident as from a number of three clamping segments.

### BRIEF DESCRIPTION OF THE DRAWINGS

The invention will now be described with reference to the drawings wherein:

FIG. 1 is a schematic, in longitudinal section, of an apparatus for vulcanizing air spring bellows, having a bellows preform inserted;

FIG. 2 shows the tool for vulcanizing air spring bellows, having a fully vulcanized air spring bellows, in a longitudinal section;

FIG. 3 shows a plan view of a clamping/spreading device according to the invention, in a converged state; and,

FIG. 4 shows the clamping/spreading device in a diverged state.

### DESCRIPTION OF THE PREFERRED EMBODIMENTS OF THE INVENTION

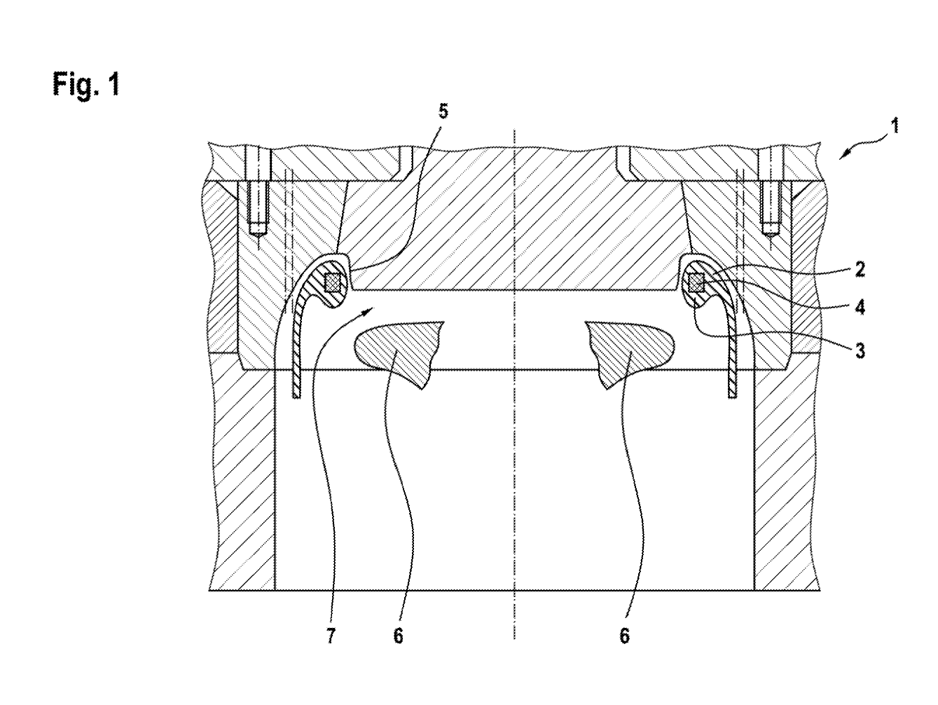

The apparatus for vulcanizing air spring bellows is schematically shown in FIG. 1 and includes a tool 1. An air spring preform 2, here shown as an upper portion, has a bead 3 having an embedded core 4. The bead 3 is guided toward a conical form 5.

Schematically shown clamping segments 6, of which only two segments are shown here, of a clamping/spreading device (not shown in more detail in FIG. 1) are converged in such a manner that the bellows preform 2 by way of the opening 7 of the latter has been capable of being pushed over the clamping segments 6.

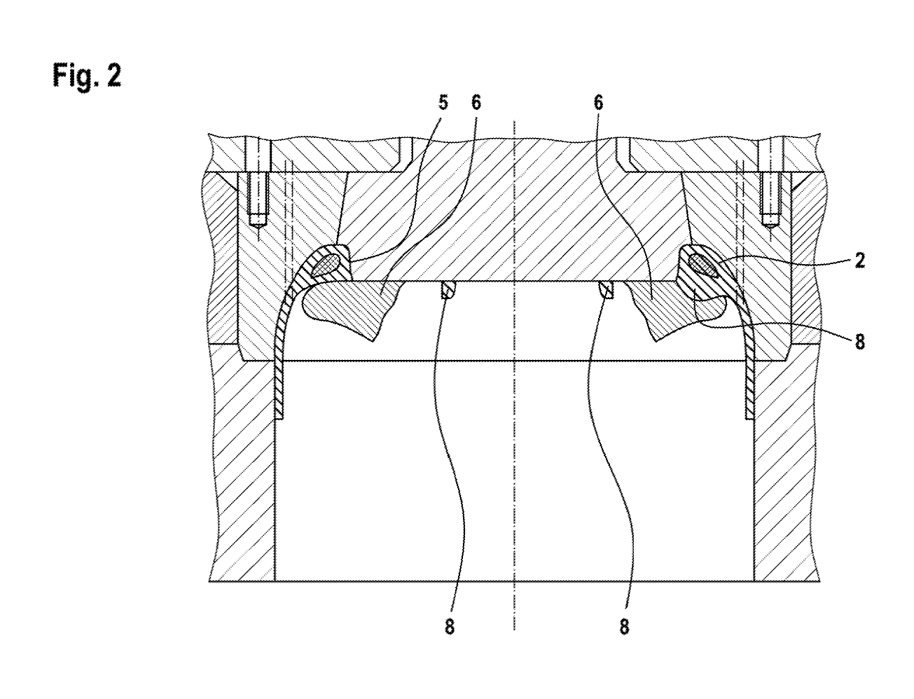

The air spring bellows 2 is shown as a fully vulcanized portion in FIG. 2. The bead 3 by way of the presently diverged clamping segments 6 of the clamping/spreading device is pressed against the conical shape 5 of the tool 1. To this end, the clamping segments 6 are diverged such that a compression of the bead 3 takes place.

Diverging the clamping segments 6 leads to gaps between the individual clamping segments 6, rubber material of the bellows 2 having penetrated the gaps in the vulcanization. The gaps are not visible in FIG. 2. The rubber that has penetrated the gaps forms protuberances 8 which are directed toward the interior of the bellows 2.

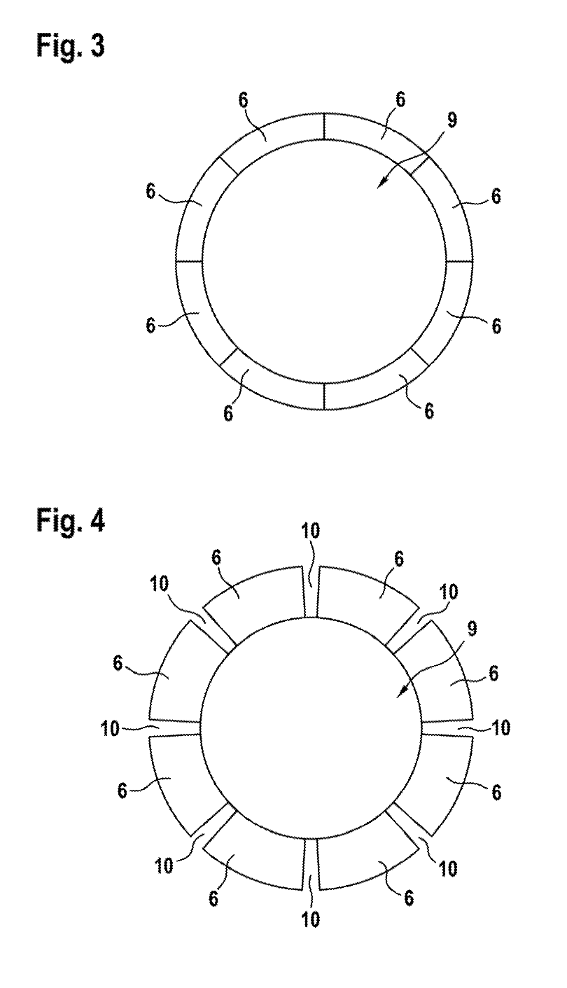

A plan view of a clamping/spreading device 9 according to the invention is shown in FIG. 3. The clamping/spreading device 9 has eight clamping segments 6 which here are shown in a converged state.

The clamping/spreading device 9 is likewise shown in a plan view in FIG. 4. The clamping segments 6 here are shown as diverged. The clamping/spreading device 9 between the clamping segments 6 has gaps 10 which have been created by diverging the clamping segments 6. As is shown in FIG. 2, the gaps 10 lead to the protuberances 8 of the rubber material. The protuberances 8 are not visible in FIG. 4.

The apparatus according to the invention enables the vulcanization of air spring bellows without heating bellows in a simple manner, wherein the clamping/spreading device is of a very simple construction.

It is understood that the foregoing description is that of the preferred embodiments of the invention and that various changes and modifications may be made thereto without departing from the spirit and scope of the invention as defined in the appended claims.

### LIST OF REFERENCE SIGNS

(Part of the Specification)

1 Air spring bellows vulcanizing tool

2 Air spring bellows

3 Bead of the air spring bellows 2

4 Core of the bead 3

5 Conical shape of the tool 1

6 Clamping segments

7 Opening of the air spring bellows 2

8 Protuberances

9 Clamping/spreading device

10 Gaps between the clamping segments 6

What is claimed is:

1. An apparatus for making a conical bellows for an air spring, the apparatus comprising:
a tool defining a conical surface for receiving said conical bellows thereagainst;
a clamping/spreading device transferable between first and second end positions;
said device having a plurality of clamping segments which are converged in said first end position to conjointly define a first outer diameter of a magnitude to permit pushing a conical bellows preform over said device thereby introducing said device into said conical bellows preform;
said plurality of clamping segments being movable so as to be diverged in said second end position wherein said segments conjointly define a second outer diameter greater than said first outer diameter so as to permit said bellows preform to be pressed by said clamping segments tightly against said conical surface from within said bellows preform during vulcanization; and,
each two mutually adjacent ones of said clamping segments conjointly defining an open gap therebetween because of the enlargement to said second outer diameter in said second end position.

2. The apparatus of claim 1, wherein the open gaps each have a width lying in a range of 1 to 30 mm in said second end position.

3. The apparatus of claim 1, wherein the open gaps each have a width lying in a range of 3 to 25 mm in said second end position.

4. The apparatus of claim 1, wherein said clamping segments are at least three in number.
